(19) United States
(12) Patent Application Publication
(10) Pub. No.: US 2021/0056093 A1
(43) Pub. Date: Feb. 25, 2021

(54) METHOD AND DEVICE FOR SUPPORTING EVENT-BASED TRANSACTION

(71) Applicant: DENSO CORPORATION, Kariya-city (JP)

(72) Inventor: Christian PREHOFER, Eching (DE)

(21) Appl. No.: 16/999,351

(22) Filed: Aug. 21, 2020

(30) Foreign Application Priority Data
Aug. 23, 2019 (DE) 102019212686.3

(51) Int. Cl. G06F 16/23; G06F 11/14; G07C 5/00; G06Q 30/06; H04W 4/44

(52) U.S. Cl. CPC G06F 16/2365; G06F 11/1474; H04W 4/44; G07C 5/008; G06Q 30/0645; G06F 16/2379

(57) ABSTRACT

A technology for supporting an event-based transaction using a continuous data stream relating to a vehicle includes: continuously acquiring a data stream of input data relating to the vehicle or relating to an environment of the vehicle from at least one device, the input data to be used in a transaction; calculating a consistency of the input data, errors in the input data, errors in an interpretation of the input data in relation to the transaction, or errors in relation to the data stream of the input data; and improving the input data to be used in the transaction by correcting or adding information before executing the transaction.

### CROSS REFERENCE TO RELATED APPLICATION

The present application claims the benefit of priority from Germany Patent Application No. 102019212686.3 filed on Aug. 23, 2019. The entire disclosure of the above application is incorporated herein by reference.

### TECHNICAL FIELD

The present disclosure relates to a method and a device for supporting an event-based transaction.

### BACKGROUND

There has been known a method for handling event data.

### SUMMARY

A technology for supporting an event-based transaction using a continuous data stream relating to a vehicle includes: continuously acquiring a data stream of input data relating to the vehicle or relating to an environment of the vehicle from at least one device, the input data to be used in a transaction; calculating a consistency of the input data, errors in the input data, errors in an interpretation of the input data in relation to the transaction, or errors in relation to the data stream of the input data; and improving the input data to be used in the transaction by correcting or adding information before executing the transaction.

### BRIEF DESCRIPTION OF DRAWINGS

Objects, features and advantages of the present disclosure will become apparent from the following detailed description made with reference to the accompanying drawings. In the drawings:

FIG. 1 shows a device according to a first embodiment of the present disclosure;

FIG. 2 shows a method according to the first embodiment of the present disclosure;

FIG. 3A shows transaction data with respect to time according to the first embodiment;

FIG. 3B shows movement data of a vehicle with respect to time according to the first embodiment;

FIG. 3C shows movement data of a mobile phone with respect to time according to the first embodiment; and

FIG. 4 shows a device according to a second embodiment of the present disclosure.

### DETAILED DESCRIPTION

With increasing integration of vehicles in networks, the terms such as connected cars or networked vehicles has arisen. Networked vehicles are understood as equipping of a vehicle with at least one module which connects at least one sensor and/or the memory capacity in the vehicle to at least one other device, network or service outside of the vehicle. Examples of this are the connection to the Internet, to facilities on the side of the road, including houses, the connection to other vehicles, the connection to the manufacturer or other companies, or, in general, the connection to other infrastructure components which do not have to be stationary.

Many services in connection with networked vehicles, for example, car sharing and vehicle monitoring, are controlled by transactions for networked vehicles. The control is based on the input of data such as sensor data of vehicles, speed or acceleration data, or sensor data of mobile phones, for example, GPS data.

The present disclosure can be applied to different transactions. One property of database transactions is that, after error-free and complete execution of a transaction, the data set is left in a consistent state. When a complete execution of a transaction is not possible, then the erroneous transaction has to be aborted and previous changes, including those in databases, have to be reversed. In financial or business transactions, to which the present disclosure may be applicable, a reversal in a simple manner is not possible in many cases. In order to bring about a completion of such a transaction, transaction completion is required to be as plausible as possible in the context of the available data, for example, the most plausible possible billing is required be performed.

In the provision of networked vehicles, mass data or big data is provided by sensors and mobile devices. Due to this abundance of data, for example, in a transaction such as car rental, the transaction can be checked via a continuous data stream from the vehicle, for example, the beginning and the end of the rental can be checked. An additional application for transactions is, for example, the calculation of fees to be paid, such as emission-based fees for vehicles.

Usually, a transaction layer and a data layer are present. Typically, transactions are based on events, by which the transactions are controlled. The events may include, for example, the start and the end time of a vehicle rental process. In networked vehicles, transactions are typically transmitted via reliable messaging services between the vehicle and a cloud-based control device.

There has been known a method that handles event data. In this method, interior and exterior data streams, for example, image data, are used as input, and from these data streams event data is determined. Based on events and the classification of combined events, an activity is generated in order to generate an event designation.

According to a first aspect of the present disclosure, a method is provided for supporting an event-based transaction using continuous data stream relating to a vehicle. The method includes: continuously acquiring a data stream of input data relating to the vehicle or relating to an environment of the vehicle from at least one device, the input data to be used in a transaction; calculating a consistency of the input data, errors in the input data, errors in an interpretation of the input data in relation to the transaction, or errors in relation to the data stream of the input data; and improving the input data to be used in the transaction by correcting or adding information before executing the transaction.

With this method, improved input data for the events of transactions can be made available and the reliability of transactions can thus be increased. By acquiring data relating to the vehicle, for example, movement data such as speed data or acceleration data, can be acquired. In data relating to the environment of the vehicle, for example, image data characterizing the relative arrangement between vehicle and road traveled or representing the environment of the road can be acquired. In the calculation step, the consistency of the data can be determined just based on the data itself, or based on the data itself and additional data, for example, speed data and movement data acquired from images. In this manner, the consistency of the speed data can be checked. Errors in the data can then be calculated when a data stream is temporarily unavailable. In this manner, errors in the interpretation can be determined, since the data is put in context relative to other data. For example, when driving toward a guide rail, in the context of map data, the conclusion can be derived that a curve is present, that is to say precisely not another vehicle which is suddenly braking in front of the reference vehicle. By correcting input data, the data quality of, for example, speed data, can be corrected in conjunction with other sensor data. Improving input data is possible in that, for example, data streams of different physical quantities make it possible to derive conclusions on speed data. Adding input data from different data streams as well makes possible an improved decision basis for events, which then trigger transactions. According to the method, the correction or improvement or respectively addition of input data occurs before executing the transaction. In this manner, it is ensured that the events which define the transactions are based on data which has a higher reliability. Thus, a high reliability of the transactions with simple structure is made possible.

According to a second aspect of the present disclosure, the at least one device, from which the input data is acquired, includes a vehicle-implemented device and a portable device. By the vehicle-implemented device and the portable device, measurement signals which are independent of one another can be evaluated for the transaction, and thus a higher reliability can be achieved.

According to a third aspect of the present disclosure, the improving of the input data is carried out based on a synchronization of the input data, a plausibility checking of the input data, or a combination of the synchronization and the plausibility checking of the input data. The data improvement based on the synchronization of the data makes it possible to have available, in addition to a data stream, an additional criterion, which results in a reliable transaction. A plausibility check of the data prevents the incorrect triggering of an event and thus an erroneous transaction.

According to a fourth aspect of the present disclosure, in the synchronization, the input data is obtained by matching transaction data of events or execution times from a transaction layer with a data stream of sensor data from a data layer. In the plausibility checking, the input data is obtained by analyzing respective transaction data from the transaction layer in conjunction with respective data streams of sensor data from the data layer. That is, the synchronization occurs by matching the transaction data of events and/or execution times from the transaction layer with a data stream of sensor data which can be present physically (for example, as movement data or image data) and/or otherwise (for example, as user data), from the data layer. Furthermore, the plausibility check is performed by an analysis of the transaction data from the data layer in conjunction with the data stream of the sensor data from the data layer. The aim is in each case to correctly assign the associated sensor data of the data stream of the data layer to the respective events and/or execution times of the transaction layer. The data structure of the data stream of the data layer can include data contents and/or data events.

In the above-described configuration, patterns of the transaction layer are matched and associated with patterns of the data layer. This is implemented by synchronization of a transaction layer with a data stream of a data layer and its respective assignable patterns from sensor data, for example, events or times. With a subsequent analysis, a plausibility check of the assignable pattern of one layer with assignable pattern of the another layer is carried out.

According to a fifth aspect of the present disclosure, the transaction is handled by a continuous processing of the input data or by a batch processing of the input data. In continuous processing of the acquired data, a real time operation for the triggering of the transactions is possible. In the batch processing of the acquired data, the computing time can be reduced, and it is possible to carry out preliminary calculations locally, which then result in a lower data transfer.

According to a sixth aspect of the present disclosure, the data stream of the input data is generated by the vehicle, another vehicle, a mobile phone, or a device positioned on a traffic route. The availability of data from another vehicle, a mobile phone or devices on a traffic route additionally enables the acquisition of mutually independent physical quantities, which increases the operational reliability.

According to a seventh aspect of the present disclosure, the improving of the input data is carried out based on a presence or absence of the data stream. By reaction to an absence of data stream, a targeted correcting and thus an increased reliability of transactions can be ensured.

According to an eighth aspect of the present disclosure, the improving of the input data is carried out based on data from sensors acquiring different physical quantities. Sensors with different physical quantities additionally increase the operational reliability.

In addition, the improving of the input data by correcting or adding information may be carried out based on data of multiple sensors relating to identical or comparable data. The associated increased operational reliability improves the quality of transactions.

According to a ninth aspect of the present disclosure, a device at least partially installed in the vehicle and configured to perform the above-described methods is provided. With such a device, before executing transactions, a high quality of input data and thus a high reliability of the transactions can be ensured. Here, the device can be partially installed in the vehicle. By the partial installation in the vehicle, the necessary bandwidth for the data transmission, for example, to a cloud-based device, can be decreased.

According to a tenth aspect of the present disclosure, the device is cloud-based, and the continuously acquired data relating to the vehicle or to the environment of the vehicle is configured to transmitted wirelessly from the vehicle to the cloud-based device. By the wireless transmission of the data to the cloud-based device, the processing cost in the vehicle can be reduced and a capacity of memory device to be used in the vehicle for executing the transactions can be reduced.

According to an eleventh aspect of the present disclosure, a processing device supporting an event-based transaction using a continuous data stream relating to a vehicle is provided. The processing device includes a transaction coordinator continuously acquiring a data stream of input data relating to the vehicle or relating to an environment of the vehicle from a source device, the input data to be used in a transaction; and a data evaluation and plausibility checker calculating a consistency of the input data, errors in the input data, errors in an interpretation of the input data in relation to the transaction, or errors in relation to the data stream of the input data. The transaction coordinator improves the input data to be used in the transaction by correcting or adding information before executing the transaction. In the processing device, the transaction coordinator and the data evaluation and plausibility checker may be implemented by one or more processors. The processing device may be provided by a cloud-based device, and the input data is configured to be transmitted wirelessly from the vehicle to the cloud-based processing device. With this processing device, advantages similar to the advantages obtained by the method according to the first aspect are obtained.

The following will describe methods for supporting event-based transactions with respect to at least one vehicle and devices for supporting event-based transactions with respect to at least one vehicle in further details with reference to the embodiment examples.

The present disclosure may be applied to a networked vehicle. The networked vehicle may be equipped with at least one module that connects the various sensors and/or memory capacities in the vehicle to at least one other device, network, or service outside of the vehicle.

A data stream from the vehicle to a cloud-based service has a large data volume. Continuous update is necessary, and the quality of the data transmitted between the vehicle and the cloud-based service may be unclear. Data stream may include, for example, floating car data in which a data set has at least one time stamp as well as current location coordinates of the vehicle. By connecting floating car data with a cloud-based service, it is possible to connect multiple vehicles with mobile sensors.

Data stream may also include GPS data and acceleration data of the vehicle. Data can be generated not only by the vehicle sensors but also by sensors included in devices positioned in the vehicle, for example, mobile phones. Examples of such sensors are cameras and distance measurement devices, for example, radar or LIDAR, which determine a distance between own vehicle and another vehicle. In addition, the data stream may include vehicle data, for example, the information that a vehicle is locked, that a combustion engine has been switched off, information on the technical state, or damage to the vehicle.

The transaction is event-based and requires a high reliability. In database transaction, after error-free and complete execution, the data set is left in a consistent state. In a financial or business transaction, a reversal in a simple manner is not possible in many cases. In order to bring about a completion of such a transaction, this completion is required to be as plausible as possible in the context of the available data, for example, the most plausible calculation is required to be performed.

Events for controlling the transaction are, for example, user data, data on payment by a user, triggered events, for example, the turning of an ignition key or the pulling of a brake as well as the triggering of purchase actions with respect to the user and external services such as ticketing services which are used, for example, in fee-based parking of vehicles in parking sites.

In order to put the data stream, events, and the transaction in a relation with one another, the following typical strategies are elaborated by the inventor of the present disclosure.

When one or more data streams of a sensor are supplying data to a cloud-based device or locally to a vehicle which contradicts an event of a transaction or a transaction itself, then a change in the event and/or the transaction is proposed. However, reliability with which the data is present in the data stream is required to be taken into consideration here. For example, data of a mobile device, for example, a mobile phone, can be erroneous for different reasons. For example, the mobile phone could have been taken or stolen from the car and thus the location data of the mobile phone is not actually in agreement with the location data of the vehicle.

When an event of a transaction is missing, for example, the beginning, the end, an interruption or a reaching of a certain service level, then a plausible option of determining the missing event based on sensor data can be provided. At this point, it is crucial that indications that an event was intended and actually occurred are collected. Following such an event, for example, a transaction can be started or completed. In this point, it does not matter whether there is an intention of the user behind it.

When a deviation exists in data streams of sensors, it is possible by a plausibility evaluation to determine which sensor is still in operation. For example, when a driving behavior is based on data of sensors in the vehicle but these sensors are obviously defective, it is possible, for example, to use sensors in a mobile device, for example, in a mobile phone, as a substitute. In many cases, this results in a loss of quality.

An approach to the implementation of the present disclosure is reproduced below.

It is assumed that transactions and multiple data streams are present. Under this assumption, data is continuously collected by at least one device, or by two or more devices. The handling of the transactions triggered by data occurs as usual.

When consistency problems or errors in the data or its interpretation with respect to the transactions and data streams are acquired, a correcting and/or adding and/or improving of the transaction data based on synchronization and a plausibility check of the data is carried out. After the correcting, adding, or improving of the data, the execution of the event-based transaction is carried out.

In this context, coordination indicates that data is obtained from multiple vehicles and layers, such as transaction layers, and subsequently it is decided whether consistency problems are present in the obtained data. A decision can be made as to whether a malfunction, an error, possible misuse, or theft is present. The details for this decision are specific to the application, and different solutions are possible for modeling specific errors of sensors or for the acquisition of theft.

### First Embodiment

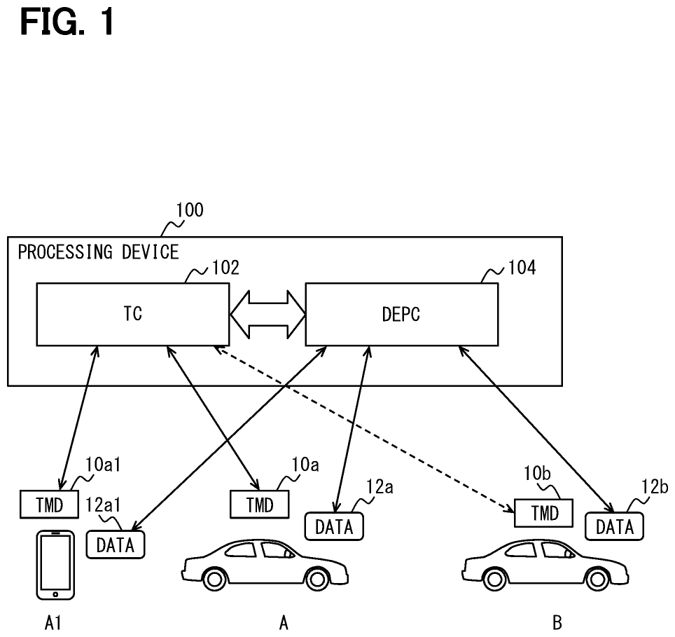

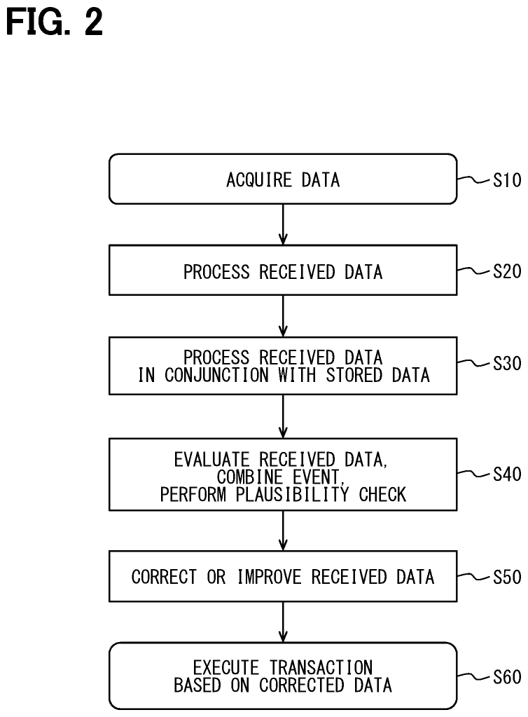

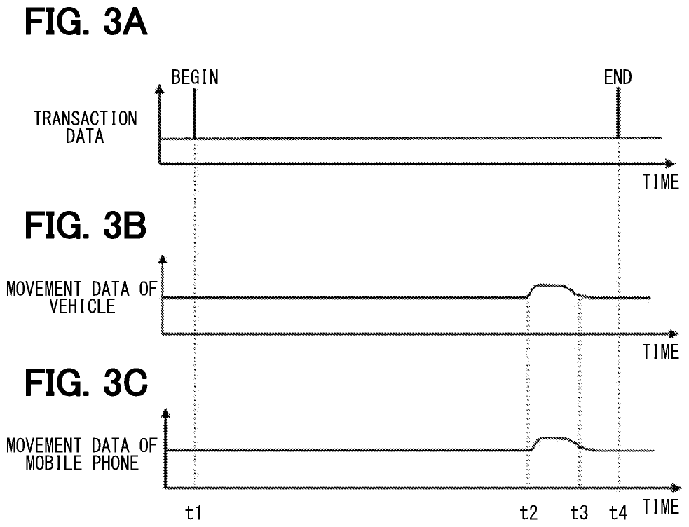

The following will describe a device and a method according to a first embodiment of the present disclosure with reference to FIG. 1, FIG. 2, FIG. 3A, FIG. 3B, and FIG. 3C.

FIG. 1 shows a structure of a device according to the present disclosure. A cloud-based service is executed by a data storage and processing device 100. The data storage and processing device 100 is also referred to as a processing device 100 below. The processing device 100 includes a transaction coordinator (TC) 102 and a data evaluation and plausibility checker (DEPC) 104. A data exchange occurs between the transaction coordinator 102 and the data evaluation and plausibility checker 104.

The data storage and processing device 100 is connected to a mobile device A1, a vehicle A and a vehicle B. The mobile device Al includes a data source (DATA) 12a1 and a transaction management device (TMD) 10a1. The vehicle A includes a data source (DATA) 12a and a transaction management device (TMD) 10a. The vehicle B includes a data source (DATA) 12b and a transaction management device (TMD) 10b. The data sources 12a1, 12a and 12b communicate wirelessly with the data evaluation and plausibility checker 104 of the processing device 100. In this manner, it is possible that data from different data sources is present in the data evaluation and plausibility checker 104.

The transaction coordinator 102 of the processing device 100 receives data from the transaction management devices 10a1, 10a and 10b. The data connection between the transaction management device 10b and the transaction coordinator 102 is drawn with a dashed line in order to represent that the communication between the transaction management device 10b and the transaction coordinator 102 delivers additional data which implements an event in the transaction coordinator 102 with a higher reliability.

A method according to the first embodiment of the present disclosure is shown in FIG. 2.

In S10, the processing device 100 acquires data streams from the data sources 12a1, 12a and 12b. In S20, the processing device 100 processes the received data, for example, in the form of batch processing or stack processing. The received data is also referred to as input data. In S30, the data evaluation and plausibility checker 104 of the processing device 100 processes the received data in conjunction with stored data. As a result, the data evaluation and plausibility checker 104 evaluates the data streams and combines the evaluation result with the plausibility check. In S50, the transaction coordinator 102 performs a correction or improvement of the input data. For example, the correction or improvement of the input data is carried out by the data connection between the transaction management device 10b and the transaction coordinator 102 shown by the dashed line in FIG. 2. In S60, the transaction coordinator 102 of the processing device 100 performs the transaction based on the corrected input data.

The following will describe an application of the first embodiment in the vehicle rental of networked vehicles.

In the vehicle rental, a user makes use of the rental of the vehicle, i.e., the user starts the rental transaction by a “beginning” event, and then returns the vehicle to a parking garage without wireless access. Due to the missing wireless access, an event of the return is missing, and thus the transaction cannot be completed. As a remedy, the data stream of sensors can be used in order to acquire an entrance into the garage and a possible movement in the garage, so that a plausibility check can be performed to determine whether the vehicle is in fact located in the garage. Here, a check of accuracy and possible theft need to be conducted, in order to take into account inaccurate sensor data and, in the case of a theft, to have prompt information on the theft.

The services which are used in the use of vehicle rental are event-based; for example, as already known, there is a beginning and an end of the rental process. The beginning can be started by the vehicle itself or, for example, by a mobile phone. Data of other vehicles can also be included, for example, in the case of platooning, in which networked vehicles are in adaptive cruise control, in the so-called electronic tow bar.

Typically, the event-based transaction layer is used for billing the user for the use of the vehicle. For the rental process, data streams of sensors from all the devices present in the vehicle or mobile phone can be used in order to check, improve or implement the actual performance of the service agreed on in the transaction. Here, a data stream of sensor data is typically not secured for the data transmission; for example, in many cases TCP is not used.

In order to reduce the cost, no additional confirmation occurs in the case of transmission of events which trigger transactions. Here, incorrectly reproduced start and end times of transactions due to, for example, delays in the communication or an incorrect use, can lead to erroneous start and end times in the transactions. By the data evaluation and plausibility checker 104, a correction of the data streams can be performed. For correcting or improving the input data or for adding input data according to the present disclosure, typical application cases are reproduced below.

Although the ending of a transaction is not triggered, that is to say the ending event is not transmitted, it is detected nonetheless via one or more data streams, for example, the rental process has been ended. Thereby, the confirmation indicating that the transaction has been completed can be transmitted, to the effect that, based on content, and thus the completing event of the transaction is nevertheless present.

In case of an erroneous start of an action, for example, in case of an error in a cloud-based server, the transaction cannot be started. However, based on sensor data present, it can be concluded that the start has occurred. Ideally, multiple data streams are used for performing such a confirmation.

For example, when an event of ending a vehicle rental is missing, the coordination is represented in FIG. 3A, FIG. 3B, and FIG. 3C according to the first embodiment.

FIG. 3A shows transaction data plotted versus time, FIG. 3B shows movement data of a vehicle plotted versus time, and FIG. 3C shows movement data of a mobile phone plotted versus time.

At time t1, a rental process starts. At this time t1, the movement data of vehicle and the movement data of mobile phone are at zero. At time t2, the vehicle begins a movement, and this movement is also verified by the movement data of mobile phone. Both the movement data of vehicle in FIG. 3B and the movement data of mobile phone in FIG. 3C return to zero at time t3.

Due to an erroneous data transmission, for example, a missing data connection via a wireless network, the transaction may not be completed. In the vehicle, the driver may be asked whether a delivery station is available in proximity, based on the available movement data of vehicle and the movement data of mobile phone, for example, in conjunction with location data of the vehicle. With this configuration, it can be assumed that the rental process has ended. Thus, the driver can trigger the end of the transaction at time t4. Alternatively, the end of the rental process can be triggered directly based on the location data of the vehicle or the movement data of vehicle and mobile phone shown in FIG. 3B and FIG. 3C.

The present disclosure is not limited to the above-described configuration. For example, a cloud-based processing device 100 may perform the data evaluation and plausibility check and subsequently performs a corresponding transaction coordination.

### Second Embodiment

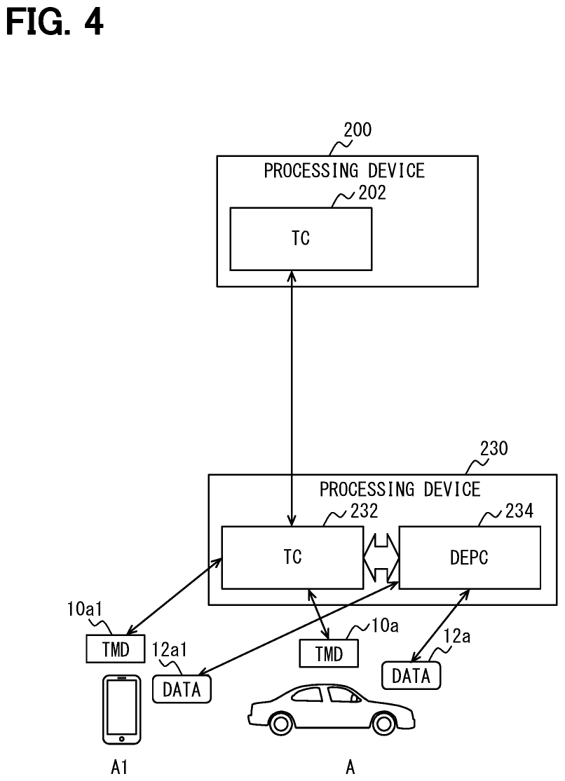

FIG. 4 shows an example according to a second embodiment of the present disclosure. In the present embodiment, a processing device 230, which is similar to the processing device 100 in the first embodiment and provided in the vehicle, includes a transaction coordinator 232. The transaction coordinator 232 according to the present embodiment includes a part of the transaction coordinator 102 of the first embodiment. The processing device 230 also includes a data evaluation and plausibility checker 234 similar to the data evaluation and plausibility checker 104 of the first embodiment.

As in the first embodiment, a vehicle A includes a transaction management device 10a and a data source 12a. A mobile phone Al includes a transaction management device 10a1 and a data source 12a1. The data evaluation and plausibility checker 234 receives data from the data sources 12a1, 12a. The transaction coordinator 232 performs data exchange with the transaction management devices 10a1, 10a.

In the second embodiment, a data storage and processing device 200, referred to as a processing device 200 below, includes a transaction coordinator 202. In the processing device 230, the data evaluation and plausibility checker 234 have an influence on the transaction coordinator 232. Due to such a structure, a reliability of transaction can be considerably increased by the processing device 230. Thus, events of transactions can be transmitted with higher reliability to the transaction coordinator 202 of the processing device 200 which is, for example, cloud-based.

The processing device 200 may be in communication with additional processing devices similar to the processing device 230. With this configuration, the amount of data to be transmitted between the vehicle and the processing device 200 may be considerably reduced.

### Other Embodiments

The correcting or improving of the input data or the adding of input data may be implemented in different ways.

In the case of errors in the data processing, a different approach may be used. When there are errors in the processing of data streams, the processing of data streams may not be performed. Then, appropriate batch processing may be provided, by means of which data processing of the lost data occurs. In the case in which the data is no longer needed at this later time, said data can then also be omitted.

In addition, in the present disclosure, a combination of batch processing and data stream processing, that is to say continuous data processing, can be performed in a system.

The present disclosure can be applied, for example, to fleet control or fleet management, in which a monitoring of the driver behavior is performed. In the case in which the sensor data is incorrect, for example, due to damage and/or coverage, for example, in tunnels, other sensors can be used, so that sensor data is confirmed or supplemented. For example, in the case of the analysis of the driver behavior, an error in that the driver is driving aggressively can be established by sensors. However, by other mobile devices, for example, a mobile phone, or via other vehicles with corresponding sensors, it can be established that this is not the case and a correction of the input data can be performed.

In the case of an erroneous interpretation of sensor data, a correction can occur, for example, based on multiple pieces of information from other data sources. For example, when a vehicle is being towed, the interpretation of distance sensor data can display a very aggressive or inappropriate manner of driving. When image data or the context of other data sources, for example, the switched off combustion engine, are then considered in addition, the towed state can be better acquired. Similarly, careful driving or unusual driving due to poorer road or weather conditions can be acquired based on a similar driving behavior of other vehicles with the corresponding sensors.

The present disclosure can also be implemented by an exhaust gas-based control. In the case of inconsistent or missing sensor data, for the setting of fees based on exhaust gases, the operating time of the vehicle and the speed have to be recorded. This can be checked by using multiple sensors and corrected in the case of lack of plausibility, for example, when the vehicle is driving in a tunnel without GPS. Data from sensors in mobile radio devices, for example, acceleration sensors can also be used in order to record the history or possible interruptions of a trip.

An additional use of the present disclosure can occur in platooning or in the electronic tow bar, in which a vehicle driving behind another vehicle saves energy and at the same time has to react to the preceding vehicle. Transactions triggered by events based on reliable data of a multitude of data sources also provide support here.

In the present disclosure, the processing device including the transaction coordinator and the data evaluation and plausibility checker may be implemented by one or more processors or microcomputers. Alternatively, the processing device may be implemented as one or more special-purposed computers. Such a special-purposed computer may be provided (i) by configuring (a) a processor and a memory programmed to execute one or more functions embodied by a computer program, or (ii) by configuring (b) a processor including one or more dedicated hardware logic circuits, or (iii) by configuring by a combination of (a) a processor and a memory programmed to execute one or more functions embodied by a computer program and (b) a processor including one or more dedicated hardware logic circuits.

What is claimed is:

1. A method for supporting an event-based transaction using a continuous data stream relating to a vehicle, the method comprising:
continuously acquiring a data stream of input data relating to the vehicle or relating to an environment of the vehicle from at least one device, the input data to be used in a transaction;
calculating a consistency of the input data, errors in the input data, errors in an interpretation of the input data in relation to the transaction, or errors in relation to the data stream of the input data; and
improving the input data to be used in the transaction by correcting or adding information before executing the transaction.

2. The method according to claim 1, wherein
the at least one device, from which the input data is acquired, includes a vehicle-implemented device and a portable device.

3. The method according to claim 1, wherein
the improving of the input data is carried out based on a synchronization or plausibility checking of the input data.

4. The method according to claim 3, wherein,
in the synchronization, the input data is obtained by matching transaction data of events or execution times from a transaction layer with a data stream of sensor data from a data layer, and
in the plausibility checking, the input data is obtained by analyzing respective transaction data from the transaction layer in conjunction with respective data streams of sensor data from the data layer.

5. The method according to claim 1, wherein
the transaction is handled by a continuous processing of the input data or by a batch processing of the input data.

6. The method according to claim 1, wherein
the data stream of the input data is generated by the vehicle, another vehicle, a mobile phone, or a device positioned on a traffic route.

7. The method according to claim 1, wherein
the improving of the input data is carried out based on a presence or absence of the data stream.

8. The method according to claim 1, wherein
the improving of the input data is carried out based on data from sensors acquiring different physical quantities.

9. A device at least partially installed in the vehicle and configured to perform the method according to claim 1.

10. The device according to claim 9, wherein
the device is a cloud-based device, and
the input data is configured to be transmitted wirelessly from the vehicle to the cloud-based device.

11. A processing device supporting an event-based transaction using a continuous data stream relating to a vehicle, the processing device comprising:
a transaction coordinator continuously acquiring a data stream of input data relating to the vehicle or relating to an environment of the vehicle from a source device, the input data to be used in a transaction; and
a data evaluation and plausibility checker calculating a consistency of the input data, errors in the input data, errors in an interpretation of the input data in relation to the transaction, or errors in relation to the data stream of the input data, the transaction coordinator improving the input data to be used in the transaction by correcting or adding information before executing the transaction.

12. The processing device according to claim 11, wherein
the processing device is a cloud-based device, and
the input data is configured to be transmitted wirelessly from the vehicle to the cloud-based processing device.

13. The processing device according to claim 11, wherein
the transaction coordinator and the data evaluation and plausibility checker are implemented by one or more processors.
